(19) United States
(12) Patent Application Publication
(10) Pub. No.: US 2012/0014510 A1
(43) Pub. Date: Jan. 19, 2012

(54) X-Ray Tube Anodes

(76) Inventors: Edward James Morton, Surrey (GB); Russell David Luggar, Surrey (GB); Martin Hunt, Hampshire (GB)

(21) Appl. No.: 13/054,066

(22) PCT Filed: Jul. 15, 2009
(86) PCT No.: PCT/GB2009/001760

§ 371 Date: Oct. 5, 2011

(30) Foreign Application Priority Data
Jul. 15, 2008 (GB) 0812864.7

(51) Int. Cl. H01J 35/12

(52) U.S. Cl. 378/141

(57) ABSTRACT

An anode for an X-ray tube includes at least one thermally conductive anode segment in contact with a rigid support member and cooling means arranged to cool the anode. The anode may further include a plurality of anode segments aligned end to end, each in contact with the support member.

### CROSS-REFERENCE TO RELATED APPLICATIONS

The present application is a national stage application of PCT/GB2009/001760, filed on Jul. 15, 2009. The present application further relies on Great Britain Patent Application Number 0812864.7, filed on Jul. 15, 2008, for priority. Both priority applications are herein incorporated by reference in their entirety.

### FIELD OF THE INVENTION

The present invention relates to X-ray tubes and in particular to the cooling of the anode of an X-ray tube.

### BACKGROUND OF THE INVENTION

It is well known to provide an X-ray tube comprising an electron source and a metal anode, wherein the anode is at a positive potential with respect to the electron source. The electric field accelerates the emitted electron towards the anode. When they strike the anode they lose some, or all, of their kinetic energy, the majority of which is released as heat. This heat can reduce the target lifetime and it is therefore common to cool the anode. Conventional methods include air cooling, wherein the anode is typically operated at ground potential with heat conduction to ambient through an air cooled heatsink, and a rotating anode, wherein the irradiated point is able to cool as it rotates around before being irradiated once more.

In some circumstances a moving X-ray source is required, which is generated by scanning an electron beam along an arcuate or linear anode. These anodes may extend to a length of several metres and it is generally complex and expensive to fabricate a single piece anode.

### SUMMARY OF THE INVENTION

Accordingly, a first aspect of the invention provides an anode for an X-ray tube comprising at least one thermally conductive anode segment in contact with a rigid support member and cooling means arranged to cool the anode.

Preferably, the cooling means comprises a cooling conduit arranged to carry coolant through the anode. This conduit may comprise a coolant tube housed within a cooling channel, which may be defined by the anode segment and the support member.

Preferably, the anode comprises a plurality of anode segments aligned end to end. This enables an anode to be built of a greater length than would easily be achieved using a single piece anode. Each anode segment may be coated with a thin film. The thin film may coat at least an exposed surface of the anode segment and may comprise a target metal. For example, the film may be a film of any one of tungsten, molybdenum, uranium and silver. Application of the metal film onto the surface of the anode may be by any one of sputter coating, electro deposition and chemical deposition. Alternatively, a thin metal foil may be brazed onto the anode segment. The thin film may have a thickness of between 30 microns and 1000 microns, preferably between 50 microns and 500 microns.

Preferably, the anode segments are formed from a material with a high thermal conductivity such as copper. The rigid backbone may preferably be formed from stainless steel. The excellent thermal matching of copper and stainless steel means that large anode segments may be fabricated with little distortion under thermal cycling and with good mechanical stability.

The plurality of anode segments may be bolted onto the rigid backbone. Alternatively, the rigid backbone may be crimped into the anode segments using a mechanical press. Crimping, in particular if used as the sole means of attaching the anode segments to the backbone, reduces the number of mechanical processes required and removes the need for bolts, which introduce the risk of gas being trapped at the base of the bolts.

The integral cooling channel may extend along the length of the backbone and may either be cut into the anode segments or into the backbone. Alternatively, the channel may be formed from aligned grooves cut into both the anode segments and the backbone. A cooling tube may extend along the cooling channel and may contain cooling fluid. Preferably, the tube is an annealed copper tube. The cooling channel may have a square or rectangular cross section or, alternatively, may have a semi-circular or substantially circular cross section. A rounded cooling channel allows better contact between the cooling tube and the anode and therefore provides more efficient cooling.

The cooling fluid may be passed into the anode through an insulated pipe section. The insulated pipe section may comprise two ceramic tubes with brazed end caps, connected at one end to a stainless steel plate. This stainless steel plate may have two ports formed through it, and each of the insulated pipe sections may be aligned with one of the ports. The plate may be mounted into the X-ray tube vacuum housing. The ceramic tubes may be connected to the cooling channel by two right-angle pipe joints and may be embedded within the anode.

### BRIEF DECRIPTION OF THE DRAWINGS

An embodiment of the present invention will now be described, by way of example only, with reference to the accompanying drawings in which:

FIG. 1a is a sectioned perspective view of an anode according to an embodiment of the invention;

FIG. 1b is a sectioned perspective view of an anode according to a further embodiment of the invention;

FIG. 2 is a section through an anode segment crimped to a backbone according to a further embodiment of the invention;

FIG. 3 is a section through an anode according to a further embodiment of the invention a round-ended cooling channel;

FIG. 4 shows a crimping tool used to crimp an anode segment to a backbone;

FIG. 5 shows a connection arrangement for the coolant tube of the anode of FIG. 1; and

FIG. 6 is a section through a connection arrangement for a coolant tube according to a further embodiment of the invention.

### DETAILED DECRIPTION OF THE INVENTION

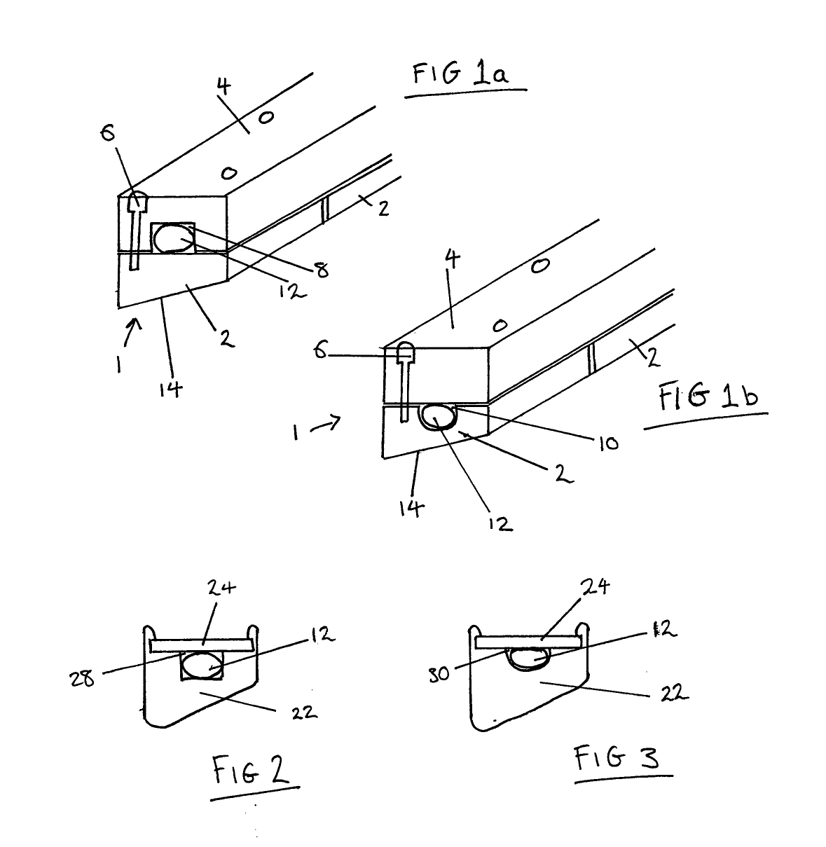

Referring to FIG. 1a, an anode 1 according to one embodiment of the invention comprises a plurality of thermally conductive anode segments 2 bolted to a rigid single piece support member in the form of a backbone 4 by bolts 6. A cooling channel 8, 10 extends along the length of the anode between the anode segments and the backbone and contains a coolant conduit in the form of a tube 12 arranged to carry the cooling fluid.

The anode segments 2 are formed from a metal such as copper and are held at a high voltage positive electrical potential with respect to an electron source. Each anode segment 2 has an angled front face 14, which is coated with a suitable target metal such as molybdenum, tungsten, silver or uranium selected to produce the required X-rays when electrons are incident upon it. This layer of target metal is applied to the front surface 14 using one of a number of methods including sputter coating, electro-deposition, chemical vapour deposition and flame spray coating. Alternatively, a thin metal foil with a thickness of 50-500 microns is brazed onto the copper anode surface 14.

Referring to FIG. 1a, the cooling channel 8 is formed in the front face of the rigid backbone 4 and extends along the length of the anode. The cooling channel 8 has a square or rectangular cross-section and contains an annealed copper coolant tube 12, which is in contact with both the copper anode segments 2, the flat rear face of which forms the front side of the channel, and the backbone 4. A cooling fluid such as oil is pumped through the coolant tube 12 to remove heat from the anode 1.

FIG. 1b shows an alternative embodiment in which the coolant channel 10 is cut into the anode segments 2. The cooling channel 10 has a semi-circular cross section with a flat rear surface of the channel being provided by the backbone 4. The semi-circular cross section provides better contact between the coolant tube 12 and the anode segments 2, therefore improving the efficiency of heat removal from the anode 1. Alternatively, the cooling channel may comprise two semi-circular recesses in both the backbone 4 and the anode segments 2, forming a cooling channel with a substantially circular cross-section.

The rigid single piece backbone 4 is formed from stainless steel and can be made using mechanically accurate and inexpensive processes such as laser cutting while the smaller copper anode segments 2 are typically fabricated using automated machining processes. The backbone 4 is formed with a flat front face and the anode segments 2 are formed with flat rear faces, which are in contact with and held against the front face of the backbone 4, so as to ensure good thermal contact between them when these flat faces are in contact. Due to the excellent thermal matching of copper and stainless steel and the good vacuum properties of both materials, large anode segments may be fabricated with little distortion under thermal cycling and with good mechanical stability.

The bolts 6 fixing the anode segments 2 onto the backbone 4 pass through bores that extend from a rear face of the backbone, through the backbone 4 to its front face, and into threaded blind bores in the anode segments 2. During assembly of the anode 1, there is the potential for gas pockets to be trapped around the base of these bolts 6. Small holes or slots may therefore be cut into the backbone or anode to connect these blind bores to the outer surface of the backbone or anode, allowing escape of the trapped pockets of gas.

Bolting a number of anode segments 2 onto a single backbone 4, as shown in FIGS. 1a and 1b, enables an anode to be built that extends for several metres. This would otherwise generally be expensive and complicated to achieve.

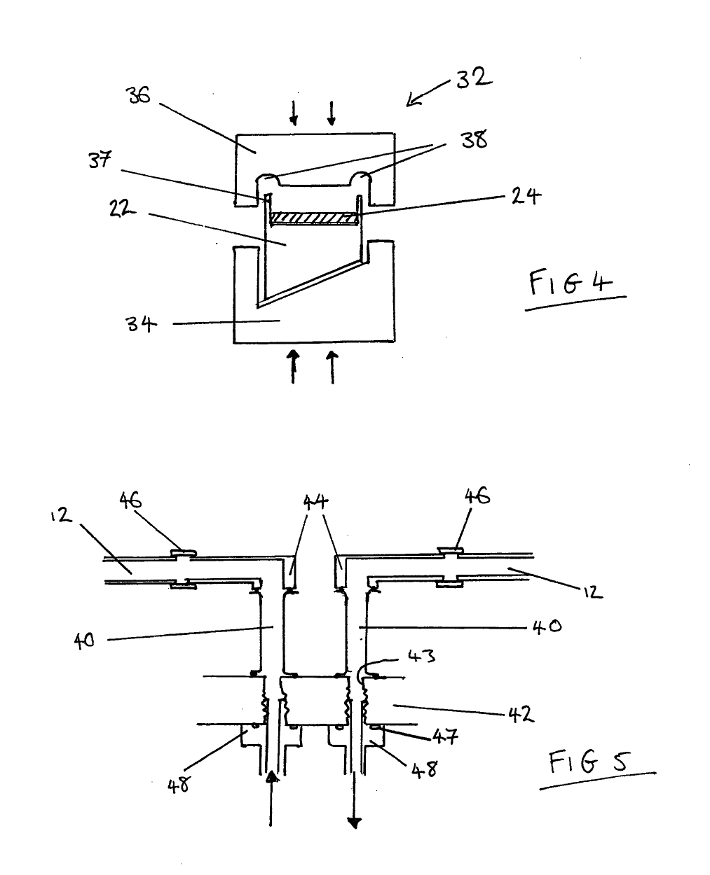

FIG. 2 shows an alternative design in which a single piece rigid backbone 24 in the form of a flat plate is crimped into the anode segments 22 using a mechanical press. A square cut cooling channel 28 is cut into the back surface of the anode segments 22 and extends along the length of the anode, being covered by the backbone 24. Coolant fluid is passed through an annealed copper coolant tube 12, which is located inside the cooling channel 28, to remove heat generated in the anode. This design reduces the machining processes required in the anode and also removes the need for bolts 6 and the associated potential trapped gas volumes at the base of the bolts.

FIG. 3 shows a similar design of anode to that shown in FIG. 2, wherein a rigid backbone 24 is crimped into anode segments 22. In this embodiment, a cooling channel 30 of curved cross-section, in this case semi-elliptical, extends along the length of the anode and is cut into the anode segments 22 with a round-ended tool. A coolant tube 12 is located inside the cooling channel 30 and is filled with a cooling fluid such as oil. The rounded cooling channel 30 provides superior contact between the coolant tube 12, which is of a rounded shape to fit in the channel 30, and the anode segments 22.

Referring to FIG. 4, the anode of FIGS. 2 and 3 is formed using a crimp tool 32. The coated copper anode segments 22 are supported in a base support 34 with walls 37 projecting upwards from the sides of the rear face of the anode segments 22. The rigid backbone 24 is placed onto the anode segments 22, fitting between the projecting anode walls 37. An upper part 36 of the crimp tool 32 has grooves 38 of a rounded cross section formed in it arranged to bend over and deform the straight copper walls 37 of the anode segments 22 against the rear face of the backbone as it is lowered towards the base support 34, crimping the backbone 24 onto the anode segments 22. Typically a force of 0.3-0.7 tonne/cm length of anode segment is required to complete the crimping process. As a result of the crimping process the crimped edges of the anode segments form a continuous rounded ridge along each side of the backbone. It will be appreciated that other crimping arrangements could be used, for example the anode segments could be crimped into grooves in the sides of the backbone, or the backbone could be crimped into engagement with the anode.

In use, the anode segments 22 are held at a relatively high electrical potential. Any sharp points on the anode can therefore lead to a localised high build up of electrostatic charge and result in electrostatic discharge. Crimping the straight copper walls 37 of the anode segments 22 around the backbone 24 provides the anode segments with rounded edges and avoids the need for fasteners such as bolts. This helps to ensure an even distribution of charge over the anode and reduces the likelihood of electrostatic discharge from the anode.

To pass the coolant fluid into the anode it is often necessary to use an electrically insulating pipe section since the anode is often operated at positive high voltage with respect to ground potential. Non-conducting, in this case ceramic, tube sections may be used to provide an electrically isolated connection between the coolant tubes 12 and an external supply of coolant fluid. The coolant fluid is pumped through the ceramic tubes into the coolant tube 12, removing the heat generated as X-rays are produced. FIG. 5 shows an insulating pipe section comprising two ceramic breaks 40 (ceramic tubes with brazed end caps) welded at a first end to a stainless steel plate 42. The plate 42 has ports 43 formed through it, and the end of each of the ceramic breaks 40 is located over a respective one of these ports 43. This stainless steel plate 42 is then mounted into the X-ray tube vacuum housing. Two right-angle pipe sections 44 are each welded at one end to a second end of one of the ceramic breaks 40. The other ends of the right-angle sections 44 are then brazed to the coolant tube 12, which extends along the cooling channel 8, 10 of the anode 1. A localised heating method is used such as induction brazing using a copper collar 46 around the coolant tube 12 and right angle pipe sections 44. Threaded connectors 48 are screwed into the ports 43, which are threaded towards their outer ends. These connectors 48 on the external side of the stainless steel plate 42 attach the insulated pipe section to external coolant circuits. These connectors 48 may be welded to the assembly or screwed in using O-ring seals 47, for example.

In order to maximise the electrostatic performance of the anode 1, it is advantageous to embed the high voltage right-angle sections of the coolant assembly, such as those shown in FIG. 5, within the anode itself. Following connection of the insulated pipe section to the coolant tube 12 it may not be possible to crimp the backbone 24 in the anode segments 22, as shown in FIGS. 2 and 3. In this case, a mechanical fixing such as the bolts 6 shown in FIGS. 1a and 1b are used.

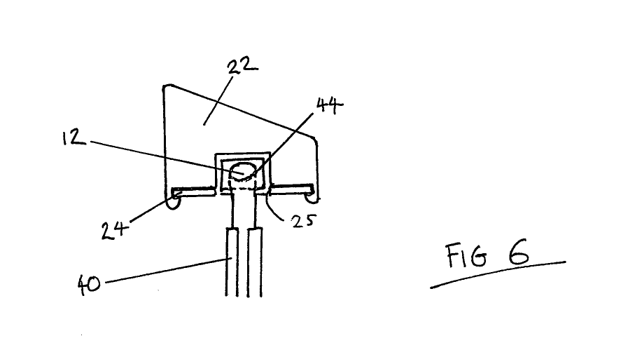

Alternatively, the pipe section can be connected to a crimped anode such as those shown in FIGS. 2 and 3 from outside of the anode. Referring to FIG. 6, a gap 25 is cut into the rigid backbone 24. The right angle sections 44 extend through the gap 25 in the backbone 24 and are brazed at one end onto the coolant tube 12. On the external side of the rigid backbone 24 the right angle sections are welded onto ceramic breaks 40, which are connected to external cooling circuits, for example as in FIG. 5.

1. An anode for an X-ray tube comprising at least one thermally conductive anode segment in contact with a rigid support member and cooling means arranged to cool the anode.

2. An anode according to claim 1, wherein the cooling means comprises a cooling conduit arranged to carry coolant through the anode.

3. An anode according to claim 2, wherein the cooling conduit comprises a coolant tube housed within a cooling channel defined by the anode segment and the support member.

4. An anode according to any preceding claim comprising a plurality of anode segments aligned end to end, each in contact with the support member.

5. An anode according to any preceding claim, wherein each anode segment is coated with a target metal.

6. An anode according to claim 5, wherein the coating is applied as a thin film.

7. An anode according to claim 5, wherein the coating is a metal foil.

8. An anode according to claim 7, wherein the metal foil has a thickness of between 50 microns and 500 microns.

9. An anode according to any of claims 5 to 8, wherein the coating is applied to a front face of the anode segment.

10. An anode according to any of claims 5 to 9, wherein the coating comprises at least one of tungsten, molybdenum, uranium and silver.

11. An anode according to any preceding claim, wherein the anode segments are made of copper.

12. An anode according to any preceding claim, wherein the support member is made of stainless steel.

13. An anode according to any preceding claim, wherein the anode segments are bolted onto the support member.

14. An anode according to any of claims 1 to 12, wherein the support member is attached to the anode segments by crimping.

15. An anode according to claim 3 or any foregoing claim, when dependent on claim 3, wherein the cooling channel is at least partially cut into the anode segments.

16. An anode according to claim 3 or any foregoing claim, when dependent on claim 3, wherein the cooling channel is at least partially cut into the support member.

17. An anode according to claim 3 or any foregoing claim, when dependent on claim 3, wherein the cooling channel has a curved cross-section.

18. An anode according to claim 3, or any foregoing claim when dependent on claim 3, wherein the coolant tube is an annealed copper tube.

19. An anode according to any preceding claim further comprising an insulating pipe section arranged to feed cooling fluid into the cooling means.

20. An anode according to claim 19, wherein the insulated pipe section comprises a ceramic tube connected to the coolant tube and a connector plate arranged to be mounted into an X-ray tube vacuum housing.

21. An anode substantially as hereinbefore described with reference to any one or more of the accompanying drawings.
